(19) United States
(12) Patent Application Publication
(10) Pub. No.: US 2015/0019808 A1
(43) Pub. Date: Jan. 15, 2015

(54) HYBRID STORAGE CONTROL SYSTEM AND METHOD

(71) Applicant: MEMORIGHT (WUHAN)CO., LTD., Wuhan, Hubei (CN)

(72) Inventors: Kun Wang, Wuhan (CN); Jianwen Hu, Wuhan (CN)

(21) Appl. No.: 14/354,576

(22) PCT Filed: Sep. 27, 2012
(86) PCT No.: PCT/CN2012/082141

§ 371 Date: Sep. 21, 2014

(30) Foreign Application Priority Data
Oct. 27, 2011 (CN) 201110332051.0

(51) Int. Cl. G06F 3/06

(52) U.S. Cl. CPC G06F 3/0685; G06F 3/0689; G06F 3/0619; G06F 3/0665; G06F 2003/0692
USPC 711/114

(57) ABSTRACT

Disclosed are a hybrid storage control system and method. Hard disk arrays are divided into a solid-state hard disk array and a disk-type hard disk array according to a type, and the solid-state hard disk array is used as a default data read source, thereby improving a data read speed of the system without reducing security performance of the system. In addition, sequential write is adopted for a manner of writing data into a normal hard disk, so that disk head seeking is not required in a write operation, and the speed of writing the data into the normal hard disk matches the speed of writing the data in a solid-state hard disk, thereby further improving a data write speed. The present invention is applicable to various storage systems including both a solid-state hard disk and a disk-type hard disk.

### BACKGROUND

1. Technical Field

The present invention relates to a method and a device of data storage, and more particularly to a hybrid storage method and device using a solid-state hard disk and a normal hard disk as a storage medium.

2. Related Art

Storage technologies develop rapidly in the prior art. A normal hard disk gradually gives place to a solid-state hard disk for use as a storage medium. A storage device in a normal hard disk is usually a disk applied with a magnetic substance, whereas a storage device in a solid-state hard disk is usually a flash memory chip. A normal hard disk has advantages such as large storage capacity and a low price, whereas a solid-state hard disk has an advantage of a high read/write speed. A current electronic device already has a configuration manner in which a normal hard disk and a solid-state hard disk coexist, and different data is stored in a different hard disk.

A redundant array of independent disks (RAID) is briefly referred to as a disk array, and was proposed by Professor D. A. Patterson at the University of California, Berkeley in the United States. In this technology, multiple hard disks are combined into an array and the hard disks in the array work in coordination to improve the speed and security of the hard disks, thereby implementing large capacity data storage. The RAID disk array technology includes several codes such as RAID0, RAID1, and RAID2.

By using the technical codes of RAID1 as an example, hard disks are first divided into at least two hard disk arrays in the codes. When data needs to be written in the hard disks, a RAID controller writes same data in both hard disk arrays, which is equivalent that double protection is configured for the data. When the data is read, the data is read from either hard disk array by default. In the technical codes of RAID1, once one hard disk array is damaged, the other hard disk array still has complete data, and the data can be recovered very easily. Also, the hard disk arrays may further support hot plugging, thereby significantly improving security of the storage device.

In a hybrid storage system having a normal hard disk and a solid-state hard disk, a speed difference in read/write performance exists between different hard disks, and a solid-state hard disk has a higher read/write speed, especially, a higher data read speed, than a normal hard disk has. If hard disks are divided into arrays without distinguishing characteristics of the hard disks, because a controller needs to match read/write speeds of different hard disks, storage control logic of the system becomes complicated and the speed is low.

### SUMMARY

### Technical Problem

The major technical problem that the present invention is to solve is to provide a hybrid storage control system and method, so as to solve a phenomenon of relatively low data read/write speeds in a hybrid hard disk array.

### Technical solution

To solve the foregoing technical problem, the present invention provides a hybrid storage control system, which includes a solid-state hard disk array and a disk-type hard disk array, and further includes a hybrid storage controller used to accomplish instruction control on the solid-state hard disk array and the disk-type hard disk array; where the instruction control includes: generating a write control instruction used to control parallel write of data in the solid-state hard disk array and the disk-type hard disk array and a read control instruction used to control read of data from the solid-state hard disk array.

Furthermore, the write control instruction used to control write of data in the disk-type hard disk array is specifically used to control data to be sequentially written in the disk-type hard disk array.

Furthermore, the instruction control of the hybrid storage controller further includes: generating a breakdown write control instruction used to control data to be written from a hard disk array that does not break down to another hard disk array.

Furthermore, the instruction control of the hybrid storage controller further includes: generating a breakdown detection control instruction used to detect whether the solid-state hard disk array and/or disk-type hard disk array breaks down.

Furthermore, the breakdown detection control instruction is specifically: a breakdown cyclic detection control instruction used to perform cyclic detection on the solid-state hard disk array and the disk-type hard disk array; or a breakdown parallel detection control instruction used to perform parallel detection on the solid-state hard disk array and the disk-type hard disk array.

The present invention further provides a hybrid storage control method, which includes the following processing process: distributing a hard disk according to a different storage medium in the hard disk into a solid-state hard disk array or a disk-type hard disk array; when a host performs a write operation, writing data in parallel in the solid-state hard disk array and the disk-type hard disk array; and when the host performs a read operation, reading data from the solid-state hard disk array by default.

Furthermore, the writing data in the disk-type hard disk array is specifically: sequentially writing the data in the disk-type hard disk array.

Furthermore, the hybrid storage control method further includes: detecting whether the solid-state hard disk array and/or the disk-type hard disk array breaks down, and when it is detected that one hard disk array breaks down, writing data from a hard disk array that does not break down to the hard disk array that breaks down.

Furthermore, the method of detecting whether the solid-state hard disk array and/or the disk-type hard disk array breaks down is specifically: performing cyclic detection on the solid-state hard disk array and the disk-type hard disk array; or performing parallel detection on the solid-state hard disk array and the disk-type hard disk array.

### Beneficial Effect

The present invention has the following beneficial effects: It is adopted that hard disk arrays are divided into a solid-state hard disk array and a disk-type hard disk array according to a type, and the solid-state hard disk array is used as a default data read source, a data read speed of a system is improved without reducing security performance of the system. In addition, sequential write is adopted for a manner of writing data into a normal hard disk, so that disk head seeking is not required in a write operation, and the speed of writing the data into the normal hard disk matches the speed of writing the data in a solid-state hard disk, thereby further improving a data write speed.

### BRIEF DESCRIPTION OF THE DRAWINGS

The present disclosure will become more fully understood from the detailed description given herein below for illustration only, and thus are not limitative of the present disclosure, and wherein:

FIG. 1 is a system structural view of a hybrid storage control system according to Embodiment 1 of the present invention; and

FIG. 2 is a flow chart of a hybrid storage control method according to Embodiment 2 of the present invention.

### DETAILED DESCRIPTION

The present invention is further illustrated below in detail with reference to specific implementation manners and accompanying drawings.

The inventive concept of the present invention uses a read/write speed difference between a hard disk and a solid-state hard disk as a functional division principle for hard disk arrays. A data read speed of a normal hard disk is much lower than that of a solid-state hard disk; although a data write speed of a normal hard disk is also slightly lower than that of a solid-state hard disk, the difference is not very large. In data read/write control, because backup of data is required, a control mechanism of writing data synchronously in a disk-type hard disk array and a solid-state hard disk array and reading data from the solid-state hard disk by default needs to be adopted.

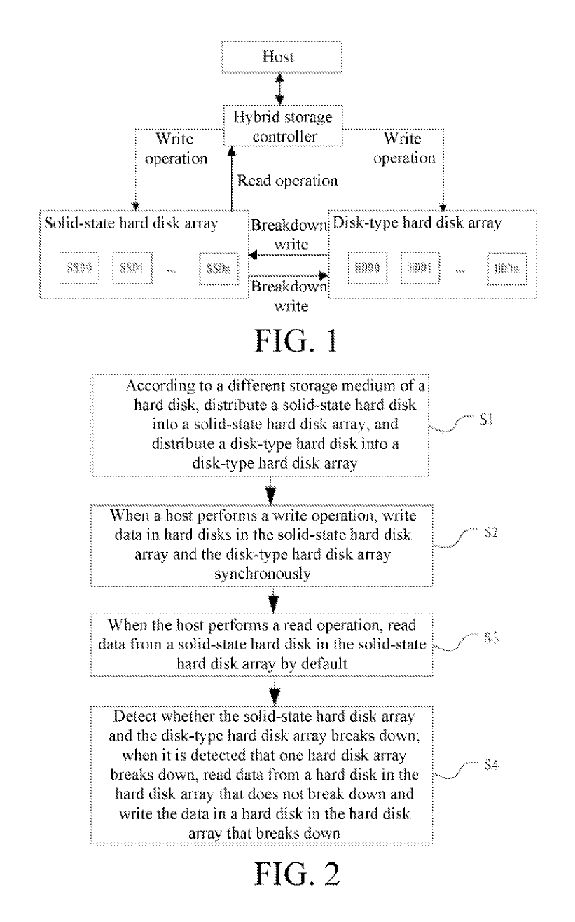

For the system structure of Embodiment 1 of the present invention shown in FIG. 1, a hybrid storage control system includes: a hybrid storage controller, a solid-state hard disk array, and a disk-type hard disk array. A host is connected to the hybrid storage controller, and accomplishes an operation of reading or writing data in hard disk arrays by using the hybrid storage controller. As shown in FIG. 1, the solid-state hard disk array includes multiple solid-state hard disks SSD0, SSD1, . . . , and SSDn, and the disk-type hard disk array includes multiple normal hard disks HDD0, HDD1, . . . , and HDDn. The hybrid storage controller accomplishes instruction parsing and instruction control on the solid-state hard disk array and the disk-type hard disk array. The instruction parsing is mainly parsing an operation instruction such as a data write operation instruction and a data read operation instruction sent by the host. The instruction control mainly include: generating a write control instruction used to control parallel write of data in the solid-state hard disk array and the disk-type hard disk array and a read control instruction used to control read of data from the solid-state hard disk array, for example: parsing the data write operation instruction sent by the host, and during write control, writing data in parallel in the solid-state hard disk array and the disk-type hard disk array through the write control instruction; and parsing the data read operation instruction sent by the host, and during read control, reading data from the solid-state hard disk array by default through the read control instruction.

During a data write operation, the write speed of the normal hard disk is still lower than that of the solid-state hard disk, that is, a problem that write speeds do not match exists. It may be set that the hybrid storage controller adopts conversion of each time of write operation on the normal hard disk into sequential write on the normal hard disk, so that the normal hard disk does not need to perform disk head seeking, thereby implementing the match between a write operation speed of the normal hard disk and a write operation speed of the solid-state hard disk.

In addition, the instruction control of the hybrid storage controller further includes: generating a breakdown detection control instruction used to detect whether the solid-state hard disk array and/or disk-type hard disk array breaks down. The breakdown detection control instruction includes, but is not limited to, a breakdown cyclic detection control instruction and a breakdown parallel detection control instruction. The breakdown cyclic detection control instruction is used to perform cyclic detection on the solid-state hard disk array and the disk-type hard disk array. The breakdown parallel detection control instruction is used to perform parallel detection on the solid-state hard disk array and the disk-type hard disk array.

When a hard disk array breaks down, the hybrid storage controller further performs breakdown control on the hard disk array, and the control process is: generating a breakdown write control instruction to control data to be written from a hard disk array that does not break down to another hard disk array.

The process of a hybrid storage control method according to Embodiment 2 of the present invention shown in FIG. 2 includes the following processing steps:

S1: According to a different storage medium of a hard disk, distribute a solid-state hard disk into a solid-state hard disk array, and distribute a disk-type hard disk into a disk-type hard disk array.

S2: When a host performs a write operation, write data in hard disks in the solid-state hard disk array and the disk-type hard disk array synchronously. The hard disk in the write disk-type hard disk array may further sequentially write the data in the disk-type hard disk.

S3: When the host performs a read operation, read data from a solid-state hard disk in the solid-state hard disk array by default.

S4: Detect whether the solid-state hard disk array and the disk-type hard disk array breaks down; when it is detected that one hard disk array breaks down, the step further includes: reading data from a hard disk in the hard disk array that does not break down and write the data in a hard disk in the hard disk array that breaks down.

In addition, there are several methods of detecting whether the solid-state hard disk array and the disk-type hard disk array breaks down; the methods include, but are not limited to, these listed as follows: performing cyclic detection on the solid-state hard disk array and the disk-type hard disk array; and performing parallel detection on the solid-state hard disk array and the disk-type hard disk array.

The foregoing content is further detailed illustration of the present invention with reference to specific implementation manners, and it should not be construed that the specific implementations of the present invention are only limited to the illustration. Therefore, a person of normal skill in the technical field of the present invention may further make several simple derivations or replacements without departing from the concept of the present invention, and these derivations or replacements should be construed as falling within the protection scope of the present invention.

What is claimed is:

1. A hybrid storage control system, comprising a solid-state hard disk array and a disk-type hard disk array, and further comprising a hybrid storage controller used to accomplish instruction control on the solid-state hard disk array and the disk-type hard disk array; wherein the instruction control comprises: generating a write control instruction used to control parallel write of data in the solid-state hard disk array and the disk-type hard disk array and a read control instruction used to control read of data from the solid-state hard disk array.

2. The hybrid storage control system according to claim 1, wherein the write control instruction used to control write of data in the disk-type hard disk array is specifically used to control data to be sequentially written in the disk-type hard disk array.

3. The hybrid storage control system according to claim 1, wherein the instruction control of the hybrid storage controller further comprises:
generating a breakdown write control instruction used to control data to be written from a hard disk array that does not break down to another hard disk array.

4. The hybrid storage control system according to claim 3, wherein the instruction control of the hybrid storage controller further comprises: generating a breakdown detection control instruction used to detect whether the solid-state hard disk array and/or disk-type hard disk array breaks down.

5. The hybrid storage control system according to claim 4, wherein the breakdown detection control instruction is specifically: a breakdown cyclic detection control instruction used to perform cyclic detection on the solid-state hard disk array and the disk-type hard disk array; or a breakdown parallel detection control instruction used to perform parallel detection on the solid-state hard disk array and the disk-type hard disk array.

6. A hybrid storage control method, comprising: distributing a hard disk according to a different storage medium in the hard disk into a solid-state hard disk array or a disk-type hard disk array; when a host performs a write operation, writing data in parallel in the solid-state hard disk array and the disk-type hard disk array; and when the host performs a read operation, reading data from the solid-state hard disk array by default.

7. The hybrid storage control method according to claim 6, wherein the writing data in the disk-type hard disk array is specifically: sequentially writing the data in the disk-type hard disk array.

8. The hybrid storage control method according to claim 6, further comprising detecting whether the solid-state hard disk array and/or the disk-type hard disk array breaks down, and when it is detected that one hard disk array breaks down, writing data from a hard disk array that does not break down to the hard disk array that breaks down.

9. The hybrid storage control method according to claim 8, wherein the method of detecting whether the solid-state hard disk array and/or the disk-type hard disk array breaks down is specifically: performing cyclic detection on the solid-state hard disk array and the disk-type hard disk array; or performing parallel detection on the solid-state hard disk array and the disk-type hard disk array.

10. The hybrid storage control system according to claim 2, wherein the instruction control of the hybrid storage controller further comprises: generating a breakdown write control instruction used to control data to be written from a hard disk array that does not break down to another hard disk array.

11. The hybrid storage control method according to claim 7, further comprising detecting whether the solid-state hard disk array and/or the disk-type hard disk array breaks down, and when it is detected that one hard disk array breaks down, writing data from a hard disk array that does not break down to the hard disk array that breaks down.

12. The hybrid storage control system according to claim 10, wherein the instruction control of the hybrid storage controller further comprises: generating a breakdown detection control instruction used to detect whether the solid-state hard disk array and/or disk-type hard disk array breaks down.

13. The hybrid storage control system according to claim 12, wherein the breakdown detection control instruction is specifically: a breakdown cyclic detection control instruction used to perform cyclic detection on the solid-state hard disk array and the disk-type hard disk array; or a breakdown parallel detection control instruction used to perform parallel detection on the solid-state hard disk array and the disk-type hard disk array.

14. The hybrid storage control method according to claim 11, wherein the method of detecting whether the solid-state hard disk array and/or the disk-type hard disk array breaks down is specifically: performing cyclic detection on the solid-state hard disk array and the disk-type hard disk array; or performing parallel detection on the solid-state hard disk array and the disk-type hard disk array.
